(19) United States
(12) Patent Application Publication
(10) Pub. No.: US 2018/0073479 A1
(43) Pub. Date: Mar. 15, 2018

(54) POWER SUPPLY DEVICE FOR VEHICLE

(71) Applicant: HONDA MOTOR CO., LTD., Tokyo (JP)

(72) Inventors: Kohei Seino, Wako-shi (JP); Hideto Yamamoto, Wako-shi (JP); Yasuhiro Ikeda, Wako-shi (JP); Naoya Hayashida, Wako-shi (JP); Kenso Imamura, Wako-shi (JP); Yusuke Takahashi, Wako-shi (JP)

(73) Assignee: HONDA MOTOR CO., LTD., Tokyo (JP)

(21) Appl. No.: 15/703,023

(22) Filed: Sep. 13, 2017

(30) Foreign Application Priority Data
Sep. 14, 2016 (JP) 2016-179655

(51) Int. Cl. F02N 11/08; B60R 16/033

(52) U.S. Cl. CPC F02N 11/0866; F02N 2200/063; B60R 16/033

(57) ABSTRACT

A power supply device for a vehicle includes: a first power supply; a second power supply which is connected to a starter, configured to start a power source, in parallel with the first power supply; and a control unit which is configured to control a starter switch configured to connect/disconnect the starter to/from any of the first power supply and the second power supply and, if the first power supply deteriorates as compared with a predetermined state, performs control to make or decrease a voltage value of the second power supply equal to or lower than a predetermined voltage value before setting the starter switch at a closed state.

### CROSS REFERENCES TO RELATED APPLICATIONS

The present application claims priority under 35 U.S.C. § 119 to Japanese Patent Application No. 2016-179655, filed Sep. 14, 2016, entitled “Power Supply Device for Vehicle.” The contents of this application are incorporated herein by reference in their entirety.

### TECHNICAL FIELD

The present disclosure relates to a power supply device for a vehicle.

### BACKGROUND

Recently, there has been known a two power supply system that is equipped with a capacitor (second power supply) in addition to a lead battery (first power supply) and configured to control the start of an engine with these two power supplies. In this two power supply system, even when one of the power supplies (first power supply) deteriorates, the start of the engine is possible in some cases by power supply from the other power supply (second power supply). In this case, an occupant cannot sense a sign of deterioration of the battery such as weakness in cranking, and therefore finds it hard to recognize deterioration of the power supply (first power supply).

For example, the repair warning system for an engine storage battery described in Japanese Patent Application Publication No. Hei 5-299121 is known as an existing technique for letting an occupant recognize deterioration of a power supply. In this repair warning system, the start of an engine is prohibited by turning on the start prohibition switch when an assumed period of time for which a storage battery is to be used elapses, for example.

### SUMMARY

However, the repair warning system for an engine storage battery described in Japanese Patent Application Publication No. Hei 5-299121 has a problem that the system design cost increases because the system needs to have the start prohibition switch which is a new additional component. Further, since the repair warning system is a system based on the assumption that one power supply is mounted, it is sometimes difficult to directly apply the technique of this repair warning system to a two power supply system.

It is preferable to provide a power supply device for a vehicle capable of letting an occupant recognize deterioration of a power supply in a two power supply system.

First aspect of the present disclosure provides a power supply device (10) for a vehicle including: a first power supply (12); a second power supply (11) which is connected to a starter (20), configured to start a power source, in parallel with the first power supply; and a control unit (14) which is configured to control a starter switch (18) configured to connect/disconnect the starter to/from any of the first power supply and the second power supply and, if the first power supply deteriorates as compared with a predetermined state, performs control to make a voltage value of the second power supply equal to or lower than a predetermined voltage value before setting the starter switch at a closed state.

Second aspect is characterized in that, the predetermined voltage value is a voltage value lower than a minimum voltage value at or above which the starter can be driven by the second power supply only.

Third aspect is characterized in that, the control unit performs control to make the voltage value of the second power supply equal to or lower than the predetermined voltage value by charging from the second power supply to the first power supply.

Fourth aspect is characterized in that, the device includes an electrical load different from the starter connected to the first power supply, and the control unit performs control to make the voltage value of the second power supply equal to or lower than the predetermined voltage value by power supply to the electrical load.

Fifth aspect is characterized in that, the control unit performs control to make the voltage value of the second power supply equal to or lower than the predetermined voltage value during a period from the start to stop of the power source.

Sixth aspect is characterized in that, the device includes a contactor which is connected between the first power supply and the second power supply, and when setting the starter switch at a closed state and causing the contactor to transition from an open state to a closed state, the control unit performs control so that a length of time needed for the contactor to transition from the open state to the closed state when the first power supply deteriorates as compared with the predetermined state is longer than that when the first power supply does not deteriorate as compared with the predetermined state.

Seventh aspect is characterized in that, the control unit performs control so that the length of time needed to transition to the closed state becomes longer as the number of times an operation of starting the power source has been performed when the first power source deteriorates as compared with the predetermined state increases.

Eighth aspect is characterized in that, the device includes a detection unit which is configured to detect manipulation by an occupant indicating an instruction to charge the second power supply, and the control unit performs charging control so that the voltage value of the second power supply becomes a voltage value larger than the predetermined voltage value if the manipulation is detected by the detection unit.

According to the first aspect, for example, since the voltage of the second power supply is decreased when the first power supply deteriorates, the engine is started using the deteriorated first power supply and the second power supply with its voltage decreased. Thereby, the engine is started using power of the deteriorated first power supply, thus enabling an occupant to recognize a sign of deterioration of the first power supply. In addition, the this aspect can be implemented by the configuration of an existing two power system without any additional component such as the start prohibition switch.

According to the second aspect, for example, the engine can be started by reliably using power of the first power supply, thus enabling an occupant to recognize a sign of deterioration of the first power supply.

According to the third aspect, for example, power generated due to voltage step down of the second power supply is used to charge the first power supply, whereby power can be utilized effectively.

According to the fourth aspect, for example, power generated due to voltage step down of the second power supply is supplied to another electrical load, whereby power can be utilized effectively.

According to the fifth aspect, for example, in the period from the start to stop of the engine during which power needs to be fed to various electrical loads such as an air conditioner, a light assembly, and a car navigation system, power generated due to voltage step down of the second power supply is supplied to these electrical loads. Thereby, power can be utilized effectively.

According to the sixth aspect, for example, in the case where the device includes the contactor connected between the first power supply and the second power supply, even when the first power supply deteriorates, the engine may be started depending on the state of the first power supply in such a way that the second power supply is charged in response to the event where the contactor transitions from the open state to the closed state at the time of starting the engine and the engine is started by power offered by the second power supply thus charged. By delaying the timing of setting the contactor at the closed state than normal (i.e., when the first power supply does not deteriorate), it is possible to increase the length of time during which the start of the engine is attempted while its startability is decreased, thus enabling an occupant to easily recognize a sign of deterioration of the first power supply.

According to the seventh aspect, for example, by gradually delaying the timing of setting the contactor at the closed state as the number of times the engine start operation has been performed with the first power supply deteriorated increases. Thereby, it is possible to increase the length of time during which the start of the engine is attempted while its startability is decreased, thus enabling an occupant to easily recognize a sign of deterioration of the first power supply.

According to the eighth aspect, for example, in a situation where the engine cannot be started merely by one of power of the first power supply and power of the second power supply, the engine can be started by charging from the first power supply to the second power supply based on occupant's manipulation. In the above explanation of the exemplary embodiment, specific elements with their reference numerals are indicated by using brackets. These specific elements are presented as mere examples in order to facilitate understanding, and thus, should not be interpreted as any limitation to the accompanying claims.

### BRIEF DESCRIPTION OF THE DRAWINGS

FIG. 1 is a functional block diagram of a power supply device 10 for a vehicle according to a first embodiment of the present disclosure.

FIG. 2 is a flowchart illustrating the operation of the power supply device 10 for a vehicle according to the first embodiment of the present disclosure.

FIG. 3 is a flowchart illustrating the operation of the power supply device 10 for a vehicle according to the first embodiment of the present disclosure.

FIG. 4 is a flowchart illustrating the operation of the power supply device 10 for a vehicle according to the first embodiment of the present disclosure.

FIG. 5 is a flowchart illustrating the operation of the power supply device 10 for a vehicle according to a fourth embodiment of the present disclosure.

### DETAILED DESCRIPTION

Hereinbelow, embodiments of a power supply device for a vehicle according to the present disclosure are described with reference to the drawings.

### First Embodiment

Hereinbelow, a power supply device 10 for a vehicle according to a first embodiment of the present disclosure is described with reference to the accompanying drawings.

(Configuration of Power Supply Device for Vehicle)

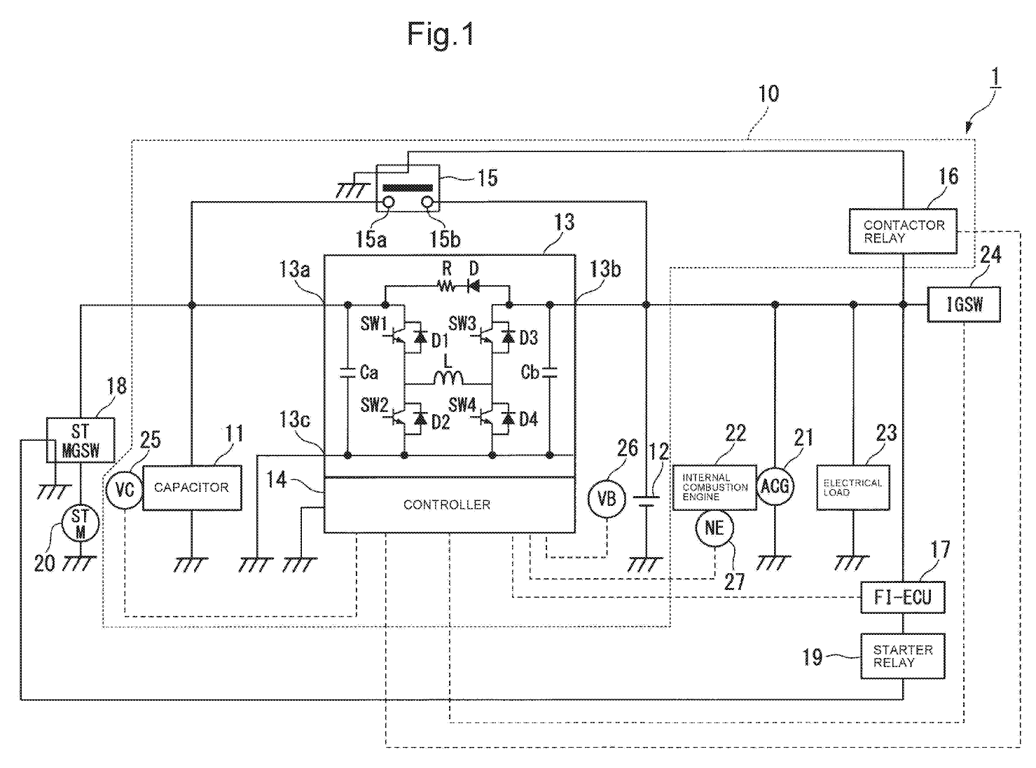

FIG. 1 is a functional block diagram of the power supply device 10 for a vehicle according to the first embodiment of the present disclosure.

The power supply device 10 for a vehicle according to this embodiment is a device mounted in a vehicle 1.

The power supply device 10 for a vehicle at least includes: a capacitor 11 and a battery 12; a DC-DC (Direct Current to Direct Current) converter 13 and a controller 14; and a contactor 15 and a contactor relay 16.

In addition to the power supply device 10 for a vehicle, the vehicle 1 includes: an FI-ECU (Fuel Injection-Electronic Control Unit) 17; a starter magnet switch (STMGSW) 18, a starter relay 19, and a starter motor (STM) 20; an AC generator (ACG) 21 and an internal combustion engine 22; an electrical load 23; an ignition switch (IGSW) 24; a second voltage sensor 25 and a first voltage sensor 26; and a speed sensor 27.

The capacitor 11 (second power supply) is an electric double-layer capacitor, an electrolytic capacitor, or a lithium ion capacitor, for example. The capacitor 11 is connected to the starter magnet switch 18. The capacitor 11 is also connected to a first I/O terminal 13a of the DC-DC converter 13 and a first terminal 15a of the contactor 15. The capacitor 11 can be electrically connected to the battery 12, the contactor relay 16, the FI-ECU 17, the AC generator 21, the electrical load 23, and the ignition switch 24 via the DC-DC converter 13 or the contactor 15.

The battery 12 (first power supply) is a secondary battery such as a lead battery. The rated voltage of the battery 12 is 12 [V], for example. The battery 12 is connected to the contactor relay 16, the FI-ECU 17, the AC generator 21, the electrical load 23, and the ignition switch 24. The battery 12 is also connected to a second I/O terminal 13b of the DC-DC converter 13 and a second terminal 15b of the contactor 15. The battery 12 can be electrically connected to the capacitor 11 and the starter magnet switch 18 via the converter 13 or the contactor 15.

The DC-DC converter 13 is capable of stepping up or stepping down a voltage between the first and second I/O terminals 13a, 13b bidirectionally under control of the controller 14. The DC-DC converter 13 is configured to charge the capacitor 11 by stepping up power generated by the AC generator 21 while the internal combustion engine 22 is in operation or regenerative power generated by the AC generator 21 during the braking of the vehicle 1 as needed and supplying it to the capacitor 11. In addition, the DC-DC converter 13 is configured to discharge the capacitor 11 by stepping up power stored in the capacitor 11 as needed and supplying it at least to the battery 12 or the electrical load 23.

The DC-DC converter 13 is an H-bridge step-up/step-down DC-DC converter, for example, and includes four first to fourth switching elements (e.g., Insulated Gate Bipolar mode Transistor (IGBT)) SW1, SW2, SW3, SW4 that are connected in a bridge.

The paired first and second switching elements SW1, SW2 in the DC-DC converter 13 are connected in series between the first I/O terminal 13a and a grounding terminal 13c. Specifically, the collector of the first switching element SW1 is connected to the first I/O terminal 13a, the emitter of the first switching element SW1 is connected to the collector of the second switching element SW2, and the emitter of the second switching element SW2 is connected to the grounding terminal 13c.

The paired third and fourth switching elements SW3, SW4 in the DC-DC converter 13 are connected in series between the second I/O terminal 13b and the grounding terminal 13c. Specifically, the collector of the third switching element SW3 is connected to the second I/O terminal 13b, the emitter of the third switching element SW3 is connected to the collector of the fourth switching element SW4, and the emitter of the fourth switching element SW4 is connected to the grounding terminal 13c.

First to fourth diodes D1 to D4 are each connected to the emitter and collector of corresponding one of the switching elements SW1, SW2, SW3, SW4 in such a way that its forward direction is the direction from the emitter toward the collector.

The DC-DC converter 13 includes a reactor L which is connected to a connecting point between the first switching element SW1 and the second switching element SW2 and a connecting point between the third switching element SW3 and the fourth switching element SW4. The DC-DC converter also includes: a first capacitor Ca which is connected between the first I/O terminal 13a and the grounding terminal 13c; and a second capacitor Cb which is connected between the second I/O terminal 13b and the grounding terminal 13c.

The DC-DC converter 13 includes a resistor Rand a diode D which are connected in series so as to directly couple the first I/O terminal 13a and the second I/O terminal 13b to each other. The diode D is disposed in such a way that its forward direction is the direction from the second I/O terminal 13b toward the first I/O terminal 13a.

The DC-DC converter 13 is driven by a signal output from the controller 14 and input to the gates of the respective switching elements SW1, SW2, SW3, SW4.

The controller 14 (control unit) is constituted of, for example: a processor such as a central processing unit (CPU); a large scale integration (LSI); an application specific integrated circuit (ASIC); and a field-programmable gate array (FPGA). The controller 14 is configured to control the bidirectional step-up/step-down operation of the DC-DC converter 13 and the connection/disconnection operation of the contactor 15 performed by the contact relay 16. The controller 14 is also configured to determine whether or not to allow the FI-ECU 17 to execute idling stop, and output a control command based on the determination to the FI-ECU 17.

The controller 14 is connected to: the second voltage sensor 25 which is configured to detect an output voltage VC of the capacitor 11; a current sensor (not illustrated) which is configured to detect a charge current and a discharge current of the capacitor 11; and a temperature sensor (not illustrated) which is configured to detect the temperature of the capacitor 11.

The controller 14 is configured to control the discharge of the battery 12 and the depth of discharge of the battery 12. The controller 14 is connected to: the first voltage sensor 26 which is configured to detect an output voltage VB of the battery 12; a current sensor (not illustrated) which is configured to detect a charge current and a discharge current of the battery 12; and a temperature sensor (not illustrated) which is configured to detect the temperature of the battery 12.

The contactor 15 is configured to switch connection/disconnection between the first and second terminals 15a, 15b of the contactor 15 according to on/off of the contactor relay 16. The on/off of the contactor relay 16 is controlled by the controller 14.

Note that the first terminal 15a of the contactor 15 is connected to the first I/O terminal 13a of the DC-DC converter 13, the cathode terminal of the capacitor 11, and the starter magnet switch 18. The second terminal 15b of the contactor 15 is connected to the second I/O terminal 13b of the DC-DC converter 13, the cathode terminal of the battery 12, the AC generator 21, and the electrical load 23. Thereby, in the connected mode, the contactor 15 connects in parallel the capacitor 11 and the battery 12 to the starter magnet switch 18 and the starter motor 20 which are connected in series.

Here, the anode terminals of the capacitor 11 and the battery 12 are grounded.

The FI-ECU 17 has a configuration in which components such as a processor such as a CPU, a program memory, a working memory, and a communication interface are connected to one another via buses. The FI-ECU 17 is configured to perform various kinds of control regarding the operation of the internal combustion engine 22 such as fuel supply and ignition timing. The FI-ECU 17 controls start/stop of the internal combustion engine 22 in response to start request/stop request signal output from the ignition switch 24 according to manipulation made by an occupant.

The FI-ECU 17 is configured to control idling stop of the internal combustion engine 22. The idling stop control is control such that the internal combustion engine 22 in operation is suspended automatically in response to satisfaction of a predetermined suspension condition, and the internal combustion engine 22 during suspension is restarted automatically in response to satisfaction of a predetermined recovery condition. The predetermined suspension condition includes, for example, a condition that the vehicle speed of the vehicle 1 is zero, the opening of an accelerator pedal is zero, and a brake pedal switch is on. The predetermined recovery condition includes, for example, a condition that the brake pedal switch is off.

The FI-ECU 17 starts the internal combustion engine 22 by performing control to turn on the starter relay 19 in response to a start request made by a signal output from the ignition switch 24 or a request for recovery from suspension due to idling stop. In addition, the FI-ECU 17 is configured to control the power generating operation of the AC generator (ACG) 21, and change the generated voltage of the AC generator 21 as desired.

The AC generator 21 is an alternating current generator coupled to a crankshaft (not illustrated) of the internal combustion engine 22 via a belt, for example. The AC generator 21 is configured to generate AC power using power of the internal combustion engine 22 during operation or power regenerated during deceleration of the vehicle 1. Here, the AC generator 21 includes, for example, a rectifier (not illustrated) which is configured to rectify a generated or regenerated AC output to a DC output. The AC generator 21 is connected to the second I/O terminal 13b of the DC-DC converter 13.

The internal combustion engine 22 (power source, engine) is started by the driving force of the starter motor (SIM) 20. The starter motor 20 is driven to rotate by application of voltage from the capacitor 11 or the battery 12 via the starter magnet switch (STMGSW) 18. The starter magnet switch 18 is configured to switch whether or not to feed power to the starter motor 20 according to on/off of the starter relay 19. In other words, the starter magnet switch 18 (starter switch) is configured to connect/disconnect the starter motor 20 (starter) to/from the capacitor 11 (second power supply) or the battery 12 (first power supply). The on/off of the starter relay 19 is controlled by the FI-ECU 17.

The starter motor 20 (starter) includes, for example, a pinion gear (not illustrated) at its rotary shaft (not illustrated). For example, the internal combustion engine 22 includes, at the crankshaft (not illustrated), a ring gear (not illustrated) which meshes with the pinion gear of the starter motor 20. Thereby, the starter motor 20 can transmit driving force to the internal combustion engine 22 by making its pinion gear mesh with the ring gear on the internal combustion engine 22 side.

The electrical load 23 is various accessories mounted in the vehicle 1. The electrical load 23 is grounded and connected to the second I/O terminal 13b of the DC-DC converter 13.

Note that the “starter switch” stated in the scope of claims includes the starter magnet switch 18 and the ignition switch 24. In addition, the controller 14 controls switching between on (closed state) and off (open state) of the starter magnet switch 18 by controlling switching between on and off of the starter relay 19 via the FI-ECU 17.

(Operation of Power Supply Device for Vehicle)

Hereinbelow, the operation of the power supply device 10 for a vehicle is described.

The controller 14 acquires a start request output from the ignition switch 24 according to manipulation made by an occupant. Upon acquisition of the start request, the controller 14 checks a deterioration flag indicating whether the battery 12 is in the power supply deterioration state.

Here, the deterioration flag is binary data of “ON” and “OFF” managed by the controller 14, and is subjected to resetting (data update) periodically (e.g., for every ten seconds) by the controller 14, for example.

The controller 14 estimates the internal resistance of the battery 12 on the basis of the output voltage VB of the battery 12 detected by the first voltage sensor 26, a charge current and a discharge current of the battery 12 detected by the current sensor (not illustrated), and the temperature of the battery 12 detected by the temperature sensor (not illustrated). Based on the internal resistance value, the controller 14 judges whether or not the battery 12 is in the state where the power supply deteriorates. Based on the judgment result, the controller 14 sets the value of the deterioration flag at “ON” or “OFF”.

If the state of the deterioration flag checked by the controller 14 turns out to be “ON”, the controller 14 checks the voltage state of the capacitor 11 via the second voltage sensor 25. If the voltage value of the capacitor 11 is higher than a predetermined voltage value (e.g., 2[V]), the controller 14 causes the DC-DC converter 13 to perform charging from the capacitor 11 to the battery 12. This charging is performed until the voltage value of the capacitor 11 becomes equal to or lower than the predetermined voltage value.

Here, for example, a voltage value lower than a minimum voltage value at or above which the internal combustion engine 22 can be started (the starter motor 20 can be driven) by the capacitor 11 only is set as the predetermined voltage value in advance.

When starting the internal combustion engine 22 in response to an event where the ignition switch 24 is turned on, the controller 14 makes the voltage value of the capacitor 11 equal to or lower than the predetermined voltage value as described above, and then starts the internal combustion engine 22 via the starter magnet switch (STMGSW) 18.

As described above, by performing charging until the voltage value of the capacitor 11 becomes equal to or lower than the predetermined voltage value, the capacitor 11 becomes incapable of starting the internal combustion engine 22 by itself, and thus power of the battery 12 is also used to start the internal combustion engine 22. By trying to start the engine using the deteriorated battery 12, the engine becomes hard to start, and thereby an occupant can recognize deterioration of the battery 12.

Note that, the FI-ECU 17 does not perform idling stop if it is checked by the controller 14 that the deterioration flag is “ON”.

Hereinbelow, the operation of the power supply device 10 for a vehicle at the time of starting is described in detail.

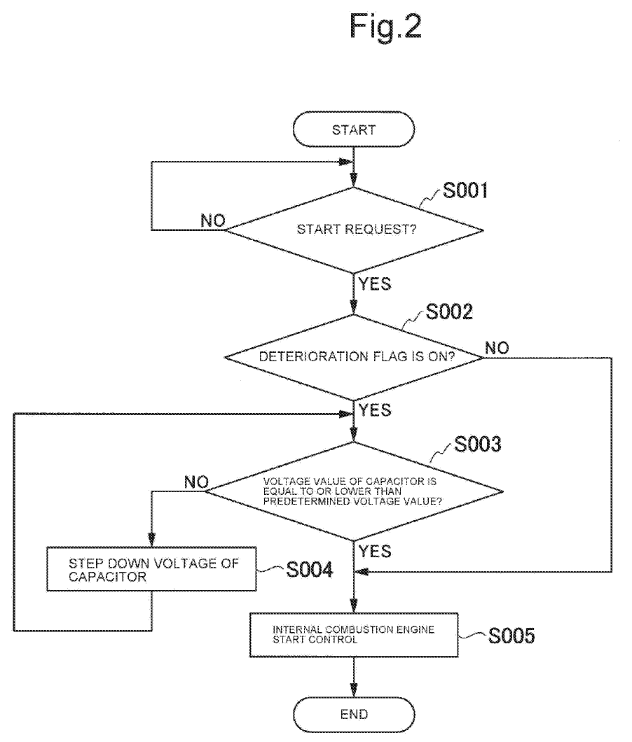

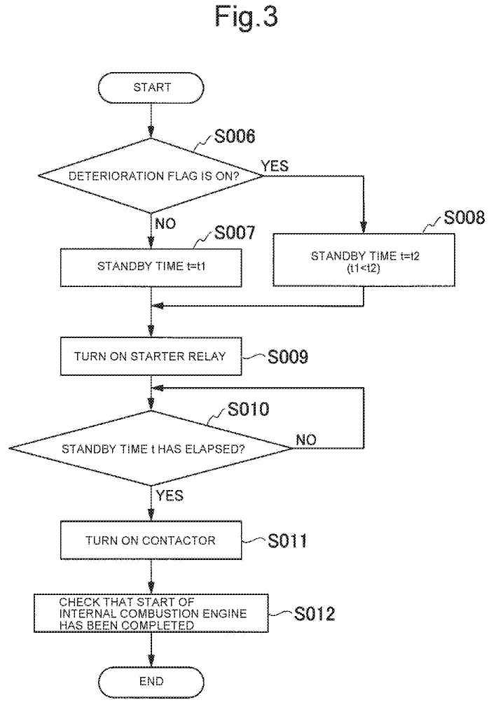

FIGS. 2 and 3 are each a flowchart illustrating the operation of the power supply device 10 for a vehicle according to the first embodiment of the present disclosure. The flowchart illustrated in FIG. 2 starts when the controller 14 of the power supply device 10 for a vehicle becomes able to accept a start request made based on a signal output from the ignition switch 24.

(Step S001) The process proceeds to Step S002 if the controller 14 acquires a start request based on a signal output from the ignition switch 24. If not, the process remains at Step S001.

(Step S002) The controller 14 checks the state of the deterioration flag. If the state of the deterioration flag thus checked is “ON”, the process proceeds to Step S003. If not, the process proceeds to Step S005.

(Step S003) The controller 14 checks the voltage value of the capacitor 11. If the voltage value of the capacitor 11 is equal to or lower than the predetermined voltage value, the process proceeds to Step S005. If not, the process proceeds to Step S004.

(Step S004) The controller 14 steps down the voltage of the capacitor 11. Then, the process returns back to Step S003.

(Step S005) The controller 14 performs control to start the internal combustion engine 22. Thus, the process in this flowchart terminates.

The flowchart in FIG. 3 illustrates the details of the start control operation of the internal combustion engine 22 in Step S005 illustrated in the flowchart in FIG. 2. Hereinbelow, the operation of the power supply device 10 for a vehicle illustrated in the flowchart in FIG. 3 is described.

(Step S006) The controller 14 checks the state of the deterioration flag. If the state of the deterioration flag thus checked is “ON”, the process proceeds to Step S008. If not, the process proceeds to Step S007.

(Step S007) The controller 14 performs control so that a length of time t, which is the length of time (standby time) needed for the contactor 15 to transition from the open state to the closed state after the turn-on of the ignition switch 24, may become equal to t1. Then, the process proceeds to Step S009.

(Step S008) The controller 14 performs control so that the length of time t, which is the length of time (standby time) needed for the contactor 15 to transition from the open state to the closed state after the turn-on of the ignition switch 24, may become equal to t2 which is longer than t1 above. Then, the process proceeds to Step S009.

(Step S009) The controller 14 performs control to turn on the starter relay 19 via the FI-ECU 17. In response to an event where the starter relay 19 is turned on, the starter magnet switch 18 feeds power to the starter motor 20. Then, the process proceeds to Step S010.

(Step S010) The controller 14 checks whether or not the standby time t has elapsed. If the standby time t has elapsed, the process proceeds to Step S011. If not, the process remains at Step S010.

(Step S011) The controller 14 turns on (closed state) the contactor 15 by performing control to turn on the contactor relay 16. Then, the process proceeds to Step S012.

(Step S012) The controller 14 checks that the start of the internal combustion engine 22 has been completed.

Thus, the process in this flowchart terminates.

Hereinbelow, the operation of the power supply device 10 for a vehicle at the time of setting the deterioration flag is described in detail.

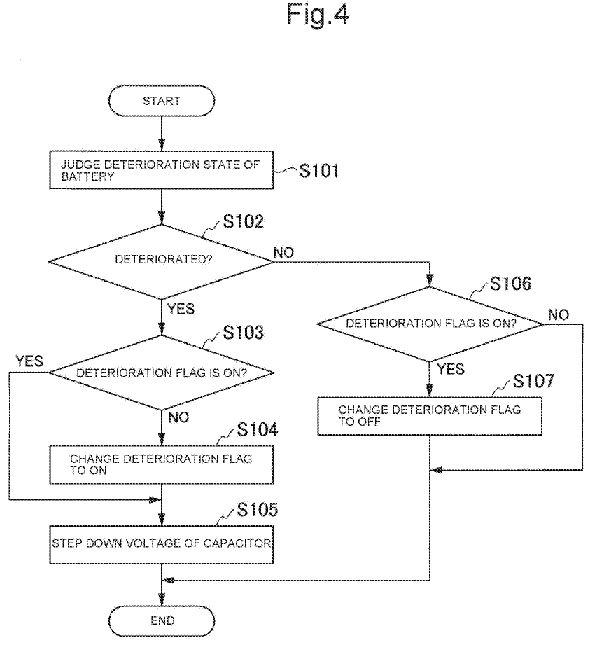

FIG. 4 is a flowchart illustrating the operation of the power supply device 10 for a vehicle according to the first embodiment of the present disclosure. This flowchart starts periodically (e.g., for every ten seconds) based on the control of the power supply device 10 for a vehicle by the controller 14.

(Step S101) The controller 14 estimates the internal resistance of the battery 12 on the basis of the output voltage VB of the battery 12 detected by the first voltage sensor 26, a charge current and a discharge current of the battery 12 detected by the current sensor (not illustrated), and the temperature of the battery 12 detected by the temperature sensor (not illustrated). Based on the internal resistance value, the controller 14 judges whether or not the battery 12 is in the state where the power supply deteriorates. Then, the process proceeds to Step S102.

(Step S102) If it is judged that the battery 12 is in the state where the power supply deteriorates, the process proceeds to Step S103. If not, the process proceeds to Step S106.

(Step S103) The controller 14 checks the state of the deterioration flag. If the state of the deterioration flag thus checked is “ON”, the process proceeds to Step S105. If not, the process proceeds to Step S104.

(Step S104) The controller 14 changes the state of the deterioration flag to “ON”. Then, the process proceeds to Step S105.

(Step S105) The controller 14 steps down the voltage of the capacitor 11. Thus, the process in this flowchart terminates.

(Step S106) The controller 14 checks the state of the deterioration flag. If the state of the deterioration flag thus checked is “ON”, the process proceeds to Step S107. If not, the process in this flowchart terminates.

(Step S107) The controller 14 changes the state of the deterioration flag to “OFF”. Thus, the process in this flowchart terminates.

As has been described above, the power supply device 10 for a vehicle according to the first embodiment decreases the voltage of the capacitor 11 when the battery 12 is deteriorated and its voltage is decreased. This makes the power supply device 10 unable to start the engine by the capacitor 11 only, and thus also use the battery 12 to start the engine. Thereby, the engine becomes hard to start depending on the deterioration state of the battery 12, whereby an occupant can recognize deterioration of the battery 12.

In addition, the power supply device 10 for a vehicle according to the first embodiment can be implemented by the configuration of a general two power supply system without any additional member such as the start prohibition switch in the repair warning system for an engine storage battery described in Japanese Patent Application Publication No. Hei 5-299121, thus making it possible to inhibit the design cost from soaring along with the complexification of the system.

Further, as described above, the power supply device 10 for a vehicle according to the first embodiment charges the battery 12 with power generated due to voltage step down of the capacitor 11, whereby power can be utilized effectively.

### Variation of First Embodiment

Hereinbelow, the power supply device 10 for a vehicle according to a variation of the first embodiment of the present disclosure is described.

The power supply device 10 for a vehicle according to the first embodiment described above performs control so that, when the battery 12 is deteriorated and its voltage is decreased, the voltage of the capacitor 11 may become equal to or lower than the predetermined voltage value by performing charging from the capacitor 11 to the battery 12.

On the other hand, the power supply device 10 for a vehicle according to the variation of the first embodiment of the present disclosure performs control so that, when the battery 12 is deteriorated and its voltage is decreased, the voltage of the capacitor 11 may become equal to or lower than the predetermined voltage value by causing the capacitor 11 to supply power to the electrical load 23 (other than the starter motor 20). Here, for example, the controller 14 performs control so that the electrical load 23, which is supplied with power normally by the battery 12, may be supplied with power by the capacitor 11 in place of the battery 12 by setting the contactor 15 at the closed state or causing the DC-DC converter 13 to step up the voltage of the battery 12.

As has been described, according to the power supply device 10 for a vehicle according to the variation of the first embodiment of the present disclosure, the engine becomes hard to start depending on the deterioration state of the battery 12, whereby an occupant can recognize deterioration of the battery 12. Moreover, this power supply device 10 for a vehicle charges the electrical load 23 (other than the starter motor 20), which is supplied with power normally by the battery 12, with power generated due to voltage step down of the capacitor 11, whereby power can be utilized effectively.

### Second Embodiment

Hereinbelow, the power supply device 10 for a vehicle according to a second embodiment of the present disclosure is described.

The power supply device 10 for a vehicle according to the second embodiment performs control so that, when the battery 12 is deteriorated and its voltage is decreased, the voltage value of the capacitor 11 may become equal to or lower than the predetermined voltage value during a period from the start to stop of the engine. For example, when the vehicle 1 approaches a destination set in a car navigation system, the controller 14 decreases the voltage value of the capacitor 11 for the next engine start.

Here, in general, during the period from the start to stop of the engine, power needs to be fed to various electrical loads such as an air conditioner, a light assembly, and a car navigation system.

As described above, the power supply device 10 for a vehicle according to the second embodiment of the present disclosure decreases the voltage value of the capacitor 11 by supplying power to the various electrical loads produced during the period from the start to stop of the engine, whereby power can be utilized effectively.

### Third Embodiment

Hereinbelow, the power supply device 10 for a vehicle according to a third embodiment of the present disclosure is described.

The power supply device 10 for a vehicle according to the third embodiment performs control so that the length of time needed for the contactor 15 to transition from the open state to the closed state after the turn-on of the ignition switch 24 when the voltage of the battery 12 does not decrease (i.e., when the deterioration flag is “OFF”) may become shorter than the length of time needed for the contactor 15 to transition from the open state to the closed state after the turn-on of the ignition switch 24 when the battery 12 is deteriorated and its voltage is decreased (i.e., when the deterioration flag is “ON”) (FIG. 3, Step S008). Thereby, after the starter magnet switch 18 (starter switch) becomes the closed state, the engine is started using power of only the capacitor 11 until the contactor 15 becomes the closed state and then, after the contactor 15 becomes the closed state, the engine is started using power of the battery 12 as well.

As described above, according to the power supply device 10 for a vehicle according to the third embodiment of the present disclosure, even when the capacitor 11 is charged by the battery 12 in response to the event where the contactor 15 transitions from the open state to the closed state at the time of starting the engine and the engine is started by power offered by the capacitor 11 thus charged, it is possible to increase the length of time during which the start of the engine is attempted while its startability is decreased by delaying the timing of setting the contactor 15 at the closed state than normal (i.e., when the first power supply does not deteriorate). This makes an occupant easily recognize deterioration of the battery 12.

### Variation of Third Embodiment

Hereinbelow, the power supply device 10 for a vehicle according to a variation of the third embodiment of the present disclosure is described.

The power supply device 10 for a vehicle according to the variation of the third embodiment performs control so that the length of time needed for the contactor 15 to transition from the open state to the closed state may become longer gradually as the number of times the engine start operation has been performed with the battery 12 deteriorated and its voltage decreased increases.

Specifically, the controller 14 of the power supply device 10 for a vehicle performs control so that, in Step S008 in FIG. 3, the value t2 being the value of the standby time t may become a larger value (become a longer length of time) as the number of times the engine start operation has been performed with the battery 12 deteriorated and its voltage decreased increases.

Thereby, after the starter magnet switch 18 (starter switch) becomes the closed state, the engine is started using power of only the capacitor 11 until the contactor 15 becomes the closed state and then, after the contactor 15 becomes the closed state, the engine is started using power of the battery 12 as well.

In this way, the power supply device 10 for a vehicle according to the variation of the third embodiment of the present disclosure performs control so that the length of time during which the start of the engine is attempted while its startability is decreased may become longer gradually as the number of times the engine start operation has been performed with the battery 12 deteriorated and its voltage decreased increases. Thus, the length of time during which the engine is hard to start is increased gradually, which makes an occupant easily recognize deterioration of the battery 12.

### Fourth Embodiment

Hereinbelow, the power supply device 10 for a vehicle according to a fourth embodiment of the present disclosure is described.

The controller 14 of the power supply device 10 for a vehicle according to the fourth embodiment includes a detection unit which is configured to detect manipulation by an occupant indicating an instruction to charge the capacitor 11. If the manipulation indicating a charging instruction is detected by the detection unit, the controller 14 causes the DC-DC converter 13 to step up the voltage of the capacitor 11, and thereby performs charging control so that the voltage value of the capacitor 11 may become a voltage value larger than a predetermined voltage value (e.g., 2[V]).

Thereby, according to the power supply device 10 for a vehicle according to the fourth embodiment, even when the battery 12 is deteriorated and its voltage is decreased but the engine can be started by increasing the voltage value of the capacitor 11, for example, the engine can be started by charging from the battery 12 to the capacitor 11. Even in the case of emergency where the engine cannot be started merely by one of power of the battery 12 and power of the capacitor 11, for example, the engine can be started urgently by stepping up, before the start of the engine, the voltage value of the capacitor 11 to a voltage value which enables the start of the engine by specific manipulation (i.e., manipulation indicating an instruction on charging from the battery 12 to the capacitor 11) of an occupant, for example.

Hereinbelow, the operation of the power supply device 10 for a vehicle according to the fourth embodiment at the time of emergency start is described in detail.

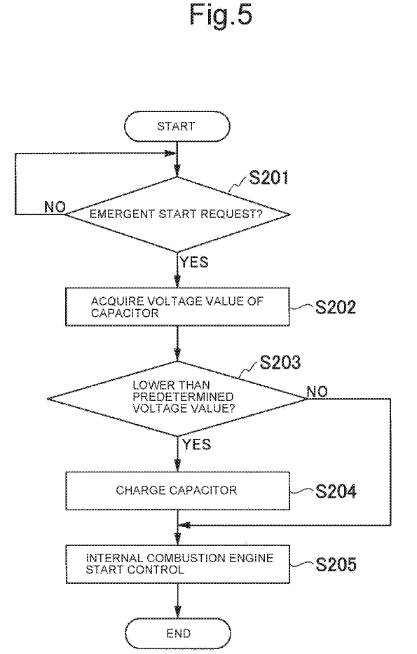

FIG. 5 is a flowchart illustrating the operation of the power supply device 10 for a vehicle according to the fourth embodiment of the present disclosure.

(Step S201) If the controller 14 acquires an emergency start request (an instruction on charging from the battery 12 to the capacitor 11) from the detection unit configured to detect manipulation indicating the emergency start request, the process proceeds to Step S202. If not, the process remains at Step S201.

(Step S202) The controller 14 acquires the voltage value of the capacitor 11 via the second voltage sensor 25. Then, the process proceeds to Step S203.

(Step S203) If the voltage value of the capacitor 11 is lower than the predetermined voltage value, the process proceeds to Step S204. If not, the process proceeds to Step S205.

(Step S204) The controller 14 causes the DC-DC converter 13 to perform charging from the battery 12 to the capacitor 11. Then, the process proceeds to Step S205.

(Step S205) The controller 14 performs control to start the internal combustion engine 22.

Thus, the process in this flowchart terminates.

Hereinabove, the embodiments of the disclosure have been described in detail; however, the specific configuration of the invention is not limited to the above embodiments, but various design changes etc. can be applied thereto within the scope not departing from the gist of the invention. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. A power supply device for a vehicle comprising:
a first power supply connected to a starter configured to start a power source;
a second power supply connected to the starter in parallel with said first power supply; and
a controller configured to control a starter switch configured to connect and disconnect said starter to and from any of said first power supply and said second power supply and,
wherein when said first power supply deteriorates more than a predetermined state, the controller performs control to make a voltage value of said second power supply equal to or lower than a predetermined voltage value before setting said starter switch to a closed state.

2. The power supply device for a vehicle according to claim 1, wherein said predetermined voltage value is a voltage value lower than a minimum voltage value at or above which said starter can be driven by said second power supply only.

3. The power supply device for a vehicle according to claim 1, wherein said controller performs the control to make the voltage value of said second power supply equal to or lower than said predetermined voltage value by charging said first power supply using power from the second power supply.

4. The power supply device for a vehicle according to claim 1, wherein
said device comprises an electrical load different from said starter connected to said first power supply, and
said controller performs the control to make the voltage value of said second power supply equal to or lower than said predetermined voltage value by supplying power to said electrical load from the second power supply.

5. The power supply device for a vehicle according to claim 1, wherein said controller performs the control to make the voltage value of said second power supply equal to or lower than said predetermined voltage value during a period after the start of the power source and before the stop of said power source.

6. The power supply device for a vehicle according to claim 1, wherein
said device comprises a contactor which is connected between said first power supply and said second power supply,
the controller sets said starter switch to the closed state and causes said contactor to transition from an open state to a closed state, and
when setting said starter switch to the closed state and causing said contactor to transition from the open state to the closed state, said controller performs control so that a first length of time needed for said contactor to transition from the open state to the closed state when said first power supply deteriorates more than the predetermined state is longer than a second length of time needed for said contactor to transition from the open state to the closed state when said first power supply does not deteriorate more than the predetermined state.

7. The power supply device for a vehicle according to claim 6, wherein said controller performs control so that the first length of time needed to transition to the closed state becomes longer as the number of times in which an operation of starting said power source has been performed with said first power supply being deteriorated more than the predetermined state increases.

8. The power supply device for a vehicle according to claim 1, further comprising:
a detector configured to detect manipulation by an occupant indicating an instruction to charge said second power supply, and
said controller performs charging control so that the voltage value of said second power supply becomes a voltage value larger than said predetermined voltage value, when the manipulation is detected by said detector.

9. The power supply device for a vehicle according to claim 1, wherein when said first power supply deteriorates more than the predetermined state, the controller decreases the voltage value of said second power supply to the voltage value equal to or lower than the predetermined voltage value such that the second power supply cannot start the power source.

10. The power supply device for a vehicle according to claim 9, wherein the starter starts the power source by using power from the second power supply and power from the first power supply after the voltage value of said second power supply decreases to the voltage value equal to or lower than the predetermined voltage value.

11. The power supply device for a vehicle according to claim 6, wherein said controller causes said contactor to transition from the open state to the closed state to charge the second power supply by the first power supply such that the voltage value of said second power supply becomes higher than the predetermined voltage value.

12. The power supply device for a vehicle according to claim 1, wherein the first power supply includes a secondary battery and the second power supply includes a capacitor.

13. A vehicle comprising the power supply device for a vehicle according to claim 1.
